(19) United States
(12) Patent Application Publication
(10) Pub. No.: US 2021/0146471 A1
(43) Pub. Date: May 20, 2021

(54) JOINING WORKPIECES VIA ADDITIVE FRICTION STIR DEPOSITION

(71) Applicant: The Boeing Company, Chicago, IL (US)

(72) Inventors: Rogie I. Rodriguez, Huntsville, AL (US); Bruno Zamorano Senderos, Huntsville, AL (US)

(21) Appl. No.: 16/684,316

(22) Filed: Nov. 14, 2019

(51) Int. Cl. B23K 20/12

(52) U.S. Cl. CPC B23K 20/128; B23K 2103/10; B23K 20/1265; B23K 20/126

(57) ABSTRACT

A method and apparatus for joining workpieces is described. The apparatus comprises a clamp configured to restrain a first workpiece against a second workpiece and an additive friction stir deposition (AFSD) machine comprising a spindle. The first workpiece is clamped to the second workpiece, and feedstock material is deposited, via rotation of the spindle, into an aperture extending through one or both of the first workpiece and the second workpiece. The deposited feedstock material forms a weld nugget that joins the first workpiece to the second workpiece.

### FIELD

The invention relates to manufacturing, and more specifically methods of joining and welding parts.

### BACKGROUND

Manufacturing encompasses a wide variety of techniques to fabricate and join parts. Welding is one family of techniques used to join parts, involving the application of heat to melt or otherwise plasticize and join parts, which are often referred to as workpieces. Fusion-based welding techniques rely on a heat source to bond workpieces by melting an interface of the workpieces or in some cases by melting a filler material. Solid-state welding techniques rely on a non-consumable tool to stir and plasticize workpiece materials to thereby bond workpieces.

In one solid-state welding technique known as friction stir welding (FSW), frictional heat is generated by moving a rotating non-consumable tool along an interface between workpieces to thereby plasticize and join the workpieces. A related technique referred to as friction stir spot welding (FSSW) employs a non-consumable tool to join workpieces arranged in a lap joint configuration through a combination of frictional heat and pressure. The non-consumable tool is plunged into the workpieces to a certain depth, and after a period, the tool is retracted from the workpiece, leaving a joint that bonds the workpieces. In FSSW, no lateral motion occurs; rather, the non-consumable tool is vertically displaced. This process forms a keyhole in the joint, however, which has adverse effects on the mechanical performance of the joint.

Other manufacturing methods employ fasteners such as rivets to form joints. A typical implementation of riveting involves inserting the tail of a rivet into an aperture and deforming the tail by applying force at the opposing head of the rivet. Deformation of the tail causes the tail to expand within the aperture, thereby creating a rivet joint. For example, a hammer or riveting machine can be used to deform the tail. Other methods employ fasteners in the form of bolts. A bolt restrains unthreaded parts between the head of the bolt and a nut threaded at an opposing end via a thread on the external surface of the bolt. Rivets and bolts add weight to the device or system in which they are implemented, however. When implemented in a vehicle, rivets and bolts decrease the fuel efficiency of the vehicle by virtue of such added weight. Further, rivets and bolts can be prone to corrosion, potentially prompting the use of coatings configured to prevent corrosion.

Thus, in view of the above, challenges exist in joining parts using current welding and joining techniques.

### SUMMARY

To address the above issues, according to one aspect of the present disclosure, a method of joining workpieces is provided. In this aspect, the method comprises positioning a workpiece assembly relative to a spindle of an additive friction stir deposition (AFSD) machine, the workpiece assembly comprising a first workpiece and a second workpiece, and clamping the first workpiece to the second workpiece. The method further comprises depositing, via at least rotation of the spindle, feedstock material from the AFSD machine into an aperture extending through one or both of the first workpiece and the second workpiece, the feedstock material deposited into the aperture forming a weld nugget that joins the first workpiece to the second workpiece.

Another aspect of the present disclosure relates to an apparatus. In this aspect, the apparatus comprises a clamp configured to restrain a first workpiece against a second workpiece. The apparatus further comprises an additive friction stir deposition (AFSD) machine comprising a spindle, the AFSD machine configured to deposit, via at least rotation of the spindle, feedstock material into an aperture extending through one or both of the first workpiece and the second workpiece, the feedstock material deposited into the aperture forming a weld nugget that joins the first workpiece to the second workpiece.

Another aspect of the present disclosure relates to another apparatus. In this aspect, the apparatus comprises a clamp configured to restrain a first workpiece against a second workpiece to form a workpiece assembly, the clamp comprising a machine-side element contacting the first workpiece and an opposite-side element contacting the second workpiece. The apparatus further comprises an additive friction stir deposition (AFSD) machine comprising a spindle, the AFSD machine configured to deposit, via at least rotation of the spindle, feedstock material into a preformed aperture extending through one or both of the first workpiece and the second workpiece of the workpiece assembly, the feedstock material deposited into the aperture forming a lap joint between the first workpiece and the second workpiece.

The features, functions, and advantages that have been discussed can be achieved independently in various embodiments or can be combined in yet other embodiments, further details of which can be seen with reference to the following description and drawings.

### BRIEF DESCRIPTION OF THE DRAWINGS

FIG. 1 shows an illustration depicting an apparatus including an additive friction stir deposition (AFSD) machine and a clamp according to an example embodiment of the present disclosure.

FIGS. 2A-2F show illustrations depicting cross-sectional views of the apparatus of FIG. 1 each representing a respective stage of a deposition process.

FIGS. 3A-3C show illustrations depicting cross-sectional views of the apparatus of FIG. 1 each representing a respective stage of another deposition process.

FIG. 4 shows a flowchart illustrating a method of joining workpieces.

### DETAILED DESCRIPTION

In view of the considerations discussed above, methods and apparatuses are provided that relate to joining workpieces via additive friction stir deposition (AFSD). AFSD employs a non-consumable tool to deposit material onto a substrate or previously formed layer. In this process, a consumable feedstock material is plasticized by heat generated from frictional stirring between a rotating spindle of an AFSD machine holding the feedstock material and the substrate/layer. Workpieces are joined via spot welds formed by depositing plasticized feedstock material from the AFSD machine into an aperture extending through one or more of the workpieces. The plasticized feedstock material deposited into the aperture forms a weld nugget in the aperture that joins the workpieces. Further, a clamp restrains the workpieces together and confines deposition to substantially within the workpieces, thereby maintaining stable positioning of the workpieces and controlling the flow of deposited feedstock. The disclosed approaches enable joint formation and workpiece bonding without the presence of keyholes that adversely affect mechanical joint performance.

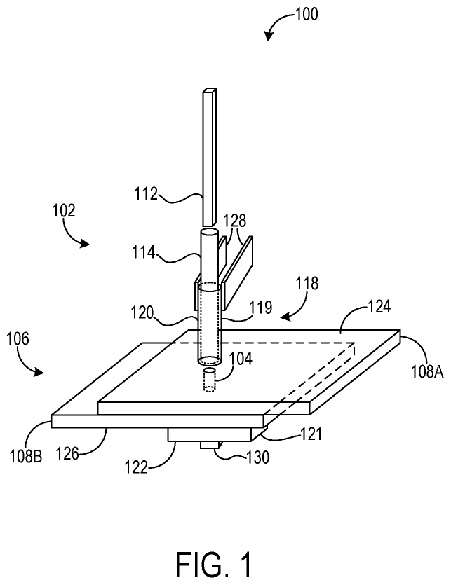

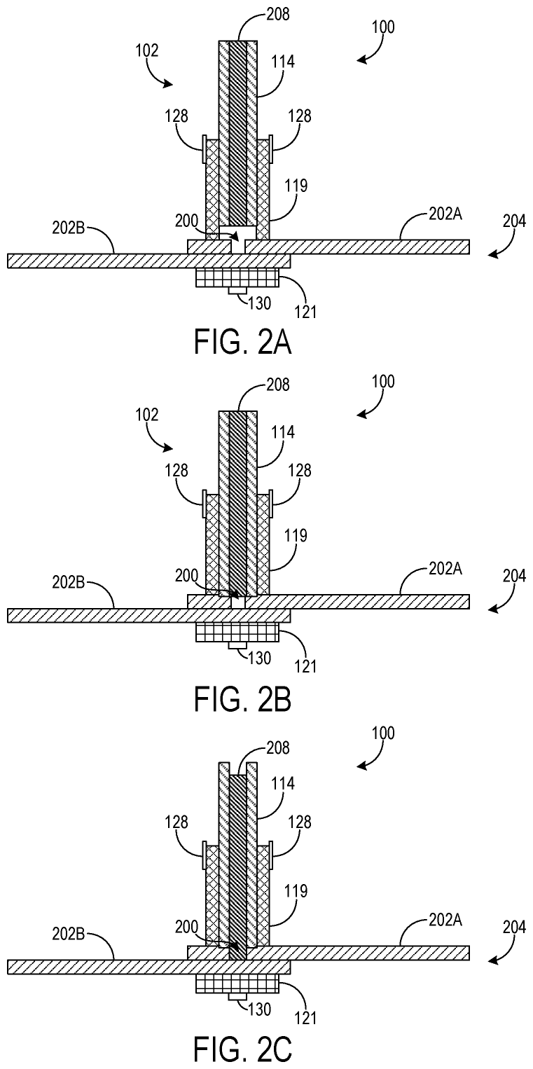

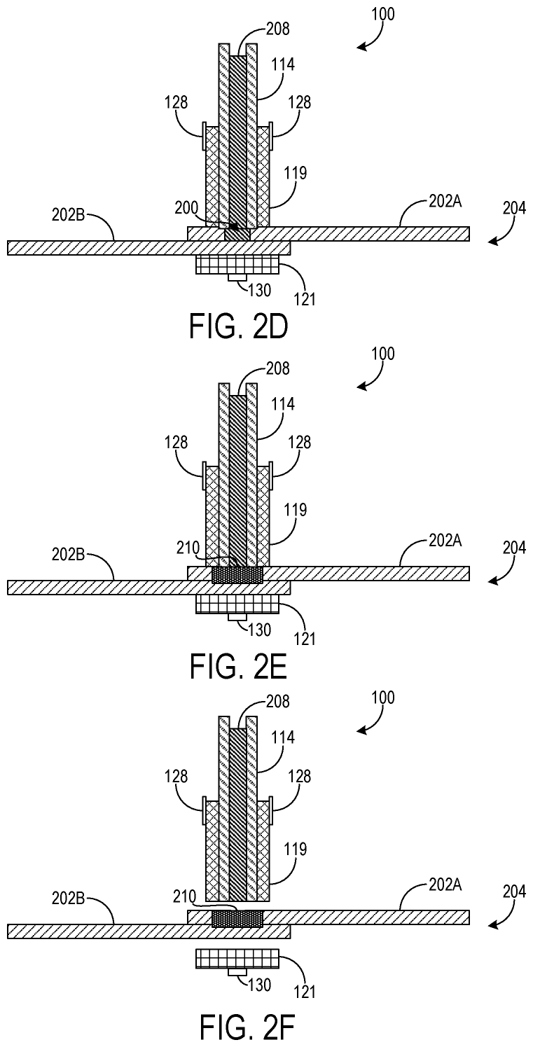

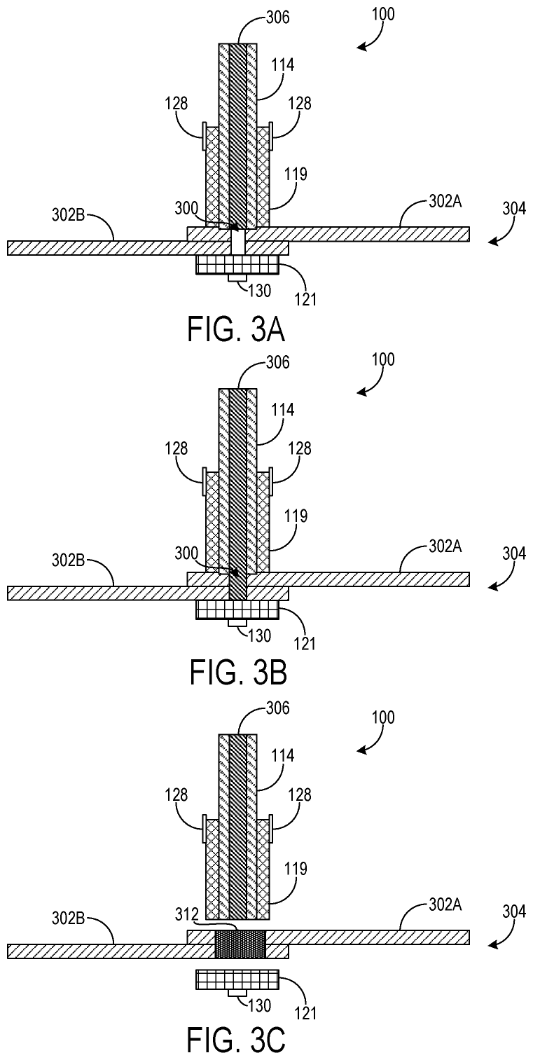

FIG. 1 illustrates an example apparatus 100 including an AFSD machine 102 configured to deposit feedstock material into an aperture 104 extending through at least a portion of a workpiece assembly 106. Workpiece assembly 106 includes a first workpiece 108A and a second workpiece 108B arranged in a lap configuration. As described in further detail below with reference to FIGS. 2A-3C, AFSD machine 102 is operable to deposit feedstock material into aperture 104 that forms a weld nugget bonding first workpiece 108A to second workpiece 108B, thereby creating a lap joint between workpieces 108. Apparatus 100 thus can be configured to perform spot welding. However, apparatus 100 can perform any suitable type of welding and joining processes. Further, apparatus 100 can bond any suitable number of workpieces.

To deposit feedstock material into aperture 104, a feedstock bar 112 is pushed through a spindle 114 placed in contact with first workpiece 108A. Frictional heating generated by a combination of downward force imparted to feedstock bar 112 (for example, by a vertical actuator), and rotation of spindle 114 against first workpiece 108A, plasticizes feedstock bar 112, thereby creating softened feedstock material. Then, the softened feedstock material is deposited into aperture 104 to form a weld nugget in aperture 104 that bonds first and second workpieces 108A and 108B together. Feedstock bar 112 can assume any suitable form, including solid and powder forms.

Apparatus 100 includes a clamp 118 configured to restrain first workpiece 108A against second workpiece 108B. Clamp 118 comprises a machine-side element 119 configured to contact and apply pressure to first workpiece 108A. In one exemplary implementation, machine-side element 119 may include a cylinder 120 at least partially surrounding spindle 114, where cylinder 120 is configured to contact and apply pressure to first workpiece 108A. In other implementations, machine-side element 119 may include other component(s) with any suitable geometry to contact and apply pressure to first workpiece 108A. For example, in another implementation, machine-side element 119 may include a rectangular component having a cylindrical hole configured to at least partially surrounds spindle 114 and apply pressure to first workpiece 108A. In yet another implementation, a separate device that does not surround spindle 114 may be used to contact and apply pressure to first workpiece 108A.

Clamp 118 comprises an opposite-side element 121 configured to contact and apply pressure to second workpiece 108B. In one exemplary implementation, opposite-side element 121 may be a backing surface that restrains workpiece assembly 106. For example, opposite-side element 121 may be a static backing surface fixed to a surrounding environment. In another exemplary implementation, opposite-side element 121 may include an anvil 122 configured to contact and apply pressure to second workpiece 108B. Opposite-side element 121 may be removable or non-removable relative to workpiece assembly 106. For example, in an implementation of joining a skin to a bulkhead, the opposite-side element 121 may be the bulkhead. In this implementation, the opposite-side element 121 would become a part of the structure after the joining process and will not be removed afterward. In another exemplary implementation, opposite-side element 121 may be removable relative to workpiece assembly 106, either by moving opposite-side element 121 away from workpiece assembly 106 or by moving workpiece assembly 106 away from opposite-side element 121.

Machine-side element 119 and opposite-side element 121 work together to apply force in substantially opposite directions to thereby restrain first and second workpieces 108A and 108B against each other. In this way, desired positioning of workpiece assembly 106 relative to AFSD machine 102, and particularly substantial axial alignment between aperture 104 and spindle 114, is maintained as spindle 114 is stirred against first workpiece 108A. Accordingly, rotation and distortion of workpiece assembly 106 due to shearing forces that might otherwise be imparted by rotation of spindle 114 can be averted.

Clamp 118 is configured to confine deposition of feedstock material from spindle 114 to substantially within workpiece assembly 106. To this end, machine-side element 119 can be placed in contact with spindle 114 and/or first workpiece 108A during feedstock deposition, such that deposited feedstock material is confined to substantially within an upper surface 124 of first workpiece 108A without protruding outside of upper surface 124. Contact between machine-side element 119 and spindle 114 can take any suitable form. For example, machine-side element 119 can be in direct contact with spindle 114, or in indirect contact with intermediate component(s) between machine-side element 119 and spindle 114, such as a lubricant and/or bearing(s). Where machine-side element 119 is in direct contact with spindle 114, one or both of the facing contact surfaces of machine-side element 119 and spindle 114 can be configured with material and/or geometric properties that minimize frictional losses due to relative motion. Where machine-side element 119 is in indirect contact with spindle 114 and is variably positioned relative to spindle 114, machine-side element 119 can be specifically positioned during deposition to confine deposited feedstock material to substantially within aperture 104 of workpiece assembly 106.

As alluded to above, aperture 104 can extend through both first and second workpieces 108A and 108B or extend through first workpiece 108A only. In particular, aperture 104 may extend from upper surface 124 of first workpiece 108A to a lower surface 126 of second workpiece 108B. In such examples, opposite-side element 121 confines deposition of feedstock material to substantially within workpiece assembly 106 by abutting second workpiece 108B and blocking the spread of deposited feedstock beyond aperture 104 out of lower surface 126.

Any suitable mechanism can be used to position machine-side element 119 and opposite-side element 121. As examples, FIG. 1 depicts a pair of upper connection arms 128 coupled to machine-side element 119, and a lower connection arm 130 coupled to opposite-side element 121, where upper connection arms 128 and lower connection arm 130 can be actuated to respectively position machine-side element 119 and opposite-side element 121. Upper connection arms 128 and lower connection arm 130 can be actuated by corresponding appendages of a robotic device, for example, or any other suitable actuation mechanism. Via connection arms 128 and 130, machine-side element 119 and opposite-side element 121 can be variably positioned relative to workpiece assembly 106 in accordance with the timing of feedstock deposition into aperture 104. For example, machine-side element 119 and opposite-side element 121 can be placed in contact with workpiece assembly 106 before, or substantially at, the time at which deposition is initiated, with such contact maintained throughout deposition. Contact further may be maintained after deposition concludes for a predetermined cooling period that enables the weld nugget formed by feedstock deposited into aperture 104 to harden and bond to workpiece assembly 106 to a desired degree. In one exemplary implementation, after the predetermined cooling period, machine-side element 119 and opposite-side element 121 may be removed from contact with workpiece assembly 106, enabling workpiece assembly 106 to be moved elsewhere and potentially enabling another workpiece assembly including an aperture to be joined as described herein. In another exemplary implementation, opposite-side 121 may become a part of the structure after the joining process and will not be removed afterward.

FIGS. 2A-2F show cross-sectional views each representing a respective stage in a process of depositing feedstock using apparatus 100. The depicted examples illustrate feedstock deposition into an aperture 200 extending through a first workpiece 202A of a workpiece assembly 204, and not through a second workpiece 202B of workpiece assembly 204.

FIG. 2A illustrates the relative arrangement between AFSD machine 102 and workpiece assembly 204 prior to initiating feedstock deposition. Prior to such relative arrangement, aperture 200 is formed in first workpiece 202A. As such, aperture 200 is referred to herein as a “preformed” aperture in contrast to welding and other manufacturing techniques in which apertures are formed as part of the welding process. Aperture 200 can be preformed in any suitable manner, such as via drilling and ablation. As a specific example, a countersink may be used to preform aperture 200. Further, aperture 200 may be preformed with any suitable shape or geometry. For example, in one implementation, aperture 200 may be formed at a right angle relative to an upper surface of first workpiece 202A, imbuing aperture 200 with a cylindrical form. In another exemplary implementation, aperture 200 may be slanted in a direction substantially perpendicular to the longitudinal axis of aperture 200. In yet another exemplary implementation, aperture 200 may be formed with a chamfer or other bevel.

Prior to initiating feedstock deposition, machine-side element 119 is placed into contact with first workpiece 202A, and opposite-side element 121 is placed into contact with second workpiece 202B. For example, machine-side element 119 can be placed into contact with first workpiece 202A via upper connection arms 128, and opposite-side element 121 can be placed into contact with second workpiece 202B via lower connection arm 130. Together, machine-side element 119 and opposite-side element 121 restrain first workpiece 202A and second workpiece 202B to maintain stable positioning of workpiece 204 and substantial axial alignment of spindle 114 with aperture 200 during later rotation of spindle 114 against first workpiece 202A, as described above. At this stage, spindle 114, which holds a feedstock bar 208 therein, is spaced away from workpiece assembly 204 and aperture 200.

Following the stage depicted in FIG. 2A, spindle 114 is placed into contact with first workpiece 202A, as illustrated in FIG. 2B. Feedstock bar 208 is moved substantially in concert with spindle 114 as spindle 114 is placed into contact with first workpiece 202A. AFSD machine 102 can be lowered as a unit to thereby place spindle 114 in such contact, for example, or alternatively, workpiece assembly 204 can be raised to achieve such contact.

Following the stage depicted in FIG. 2B, feedstock bar 208 is fed downward through spindle 114 to place feedstock bar 208 in aperture 200 and in contact with second workpiece 202B, as shown in FIG. 2C. During this stage, spindle 114 is rotated against first workpiece 202A, with feedstock bar 208 rotating against second workpiece 202B. Frictional heat generated by the rotation of spindle 114 against first workpiece 202A may plasticize one or more portion(s) of first workpiece 202A in contact with or proximate to spindle 114. In addition, frictional heat generated by rotation of feedstock bar 208 against second workpiece 202B may plasticize one or more portion(s) of feedstock bar 208 in contact with second workpiece 202B. The frictional heat generated by stirring feedstock bar 208 against second workpiece 202B may also plasticize a portion of second workpiece 202B in contact with or proximate to feedstock bar 208.

As shown in FIG. 2D, a portion of feedstock bar 208 that is plasticized via rotation of feedstock bar 208 against second workpiece 202B is deposited into aperture 200. Feedstock deposition is confined to substantially within workpiece assembly 204 via contact between machine-side element 119 and first workpiece 202A. In this way, excess flash can be contained and the undesired spread of a melt pool averted. As described below, the plasticized portion of feedstock bar 208 deposited in aperture 200 may combine with plasticized portions of first workpiece 202A and/or second workpiece 202B to form a weld nugget joining first workpiece 202A and second workpiece 202B.

In one exemplary implementation, the diameter or width of aperture 200 may be greater than the diameter or width of feedstock bar 208, enabling feedstock bar 208 to make contact with second workpiece 202B when inserted into aperture 200. However, in other implementations, the diameter or width of aperture 200 may be less than the diameter or width of feedstock bar 208, enabling feedstock bar 208 to make contact with first workpiece 202A, with plasticized feedstock derived from feedstock bar 208 making contact with second workpiece 202B, rather than feedstock bar 208 itself achieving such contact.

As plasticized feedstock material from feedstock bar 208 is deposited into aperture 200, a mechanical and metallurgical bond is formed among the deposited feedstock material, first workpiece 202A, and second workpiece 202B. These bonded components include the deposited feedstock material with any portions of workpiece assembly 204 that are plasticized as spindle 114 and feedstock bar 208 are rotated, as described above. The bonded components form a weld nugget 210 that joins first workpiece 202A with second workpiece 202B, as shown in FIG. 2E. In the depicted example, this bond is of the form of a lap joint, though other joint types may be formed between workpieces as noted above. In an exemplary implementation, weld nugget 210 can be formed without substantially leaving any gaps between deposited feedstock and first and second workpieces 202A and 202B, which can help to avert corrosion in workpiece assembly 204 and mechanical degradation of the lap joint.

FIG. 2E also illustrates examples in which the volume of weld nugget 210 is greater than the volume of aperture 200. This volume characteristic of weld nugget 210 can arise from its potential composition noted above of not only deposited feedstock material but portions of first workpiece 202A and/or second workpiece 202B. In the depicted example, the lateral dimension of weld nugget 210 exceeds the lateral dimension of aperture 200, with a portion of weld nugget 210 extending into second workpiece 202B.

After depositing a desired portion of feedstock material, feedstock deposition and formation of weld nugget 210 is ceased. For example, feedback deposition could be ceased by disabling downward actuation of feedstock bar 208 and/or rotation of spindle 114. Then, machine-side element 119 and opposite-side element 121 are removed from contact with workpiece assembly 204 after a predetermined cooling period. As described above, the predetermined cooling period can be selected such that weld nugget 210 achieves a desired degree of cooling and/or hardening, providing a desired degree of bonding between first and second workpieces 204A and 204B without undesired flow of weld nugget 210. After removing machine-side element 119 and opposite-side element 121 from contact with workpiece assembly 204, workpiece assembly 204 is exposed, and can be removed for further processing.

FIGS. 3A-3C show cross-sectional views each representing a respective stage in a process of depositing feedstock using apparatus 100 into an aperture 300 extending through both of a first workpiece 302A of a workpiece assembly 304 and a second workpiece 302B of workpiece assembly 304. Aperture 300 is preformed in first workpiece 302A and second workpiece 302B via the methods described above.

At the stage depicted in FIG. 3A, spindle 114, holding a feedstock bar 306, is placed into contact with first workpiece 302A. Machine-side element 119 is placed in contact with first workpiece 302A and opposite-side element 121 is placed into contact with second workpiece 302B. For example, machine-side element 119 can be placed into contact with first workpiece 302A via upper connection arms 128, and opposite-side element 121 can be placed into contact with second workpiece 302B via lower connection arm 130. Together, machine-side element 119 and opposite-side element 121 restrain first workpiece 302A against second workpiece 302B and confine feedstock deposition to substantially within workpiece assembly 304.

Following the stage depicted in FIG. 3A, a portion of feedstock bar 306 is deposited into aperture 300 by actuating feedstock bar 306 downward and plasticizing a portion of feedstock bar 306 proximate aperture 300 via frictional heating produced by rotating spindle 114 against first workpiece 302A. Feedstock deposition is confined to substantially within workpiece assembly 304 via contact between machine-side element 119 and first workpiece 302A, and contact between opposite-side element 121 and second workpiece 302B. Deposited feedstock is thus prevented from protruding beyond an upper surface of first workpiece 302A or a lower surface of second workpiece 302B.

FIG. 3C depicts the completion of feedstock deposition, which has formed a weld nugget 312 joining first workpiece 302A to second workpiece 302B. In this example, the volume of weld nugget 312 is greater than the volume of aperture 300. This volume characteristic of weld nugget 312 can arise from its potential composition of not only deposited feedstock material but portions of first workpiece 302A and/or second workpiece 302B that were plasticized and bonded to deposited feedstock. After depositing a desired portion of feedstock to form weld nugget 312, feedstock deposition and formation of weld nugget 312 is ceased, for example by disabling downward actuation of feedstock bar 306 and/or rotation of spindle 114. After a cooling period that allows desired hardening of weld nugget and bonding of first workpiece 302A and second workpiece 302B, machine-side element 119 and opposite-side element 121 are removed from contact with workpiece assembly 304.

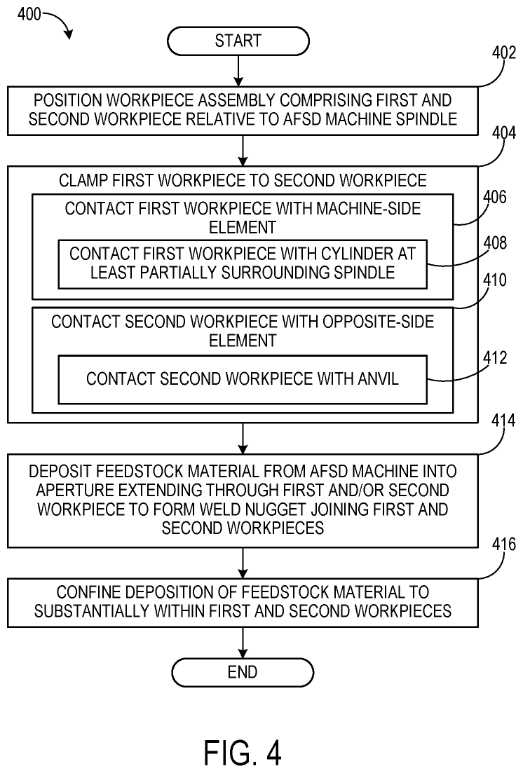

FIG. 4 depicts a flowchart illustrating a method 400 of joining workpieces. Method 400 may be implemented using apparatus 100, for example.

At 402, a workpiece assembly is positioned relative to a spindle of an AFSD machine (for example, spindle 114 of AFSD machine 102). The workpiece assembly comprises a first workpiece (for example, first workpiece 202A) and a second workpiece (for example, second workpiece 202B).

At 404, a first workpiece is clamped to the second workpiece. Clamping the first workpiece to the second workpiece may include, at 406, contacting the first workpiece with a machine-side element (for example, machine-side element 119). Contacting the first workpiece with a machine-side element may include, at 408, contacting the first workpiece with a cylinder (for example, cylinder 120) at least partially surrounding the spindle. Clamping the first workpiece to the second workpiece may include, at 410, contacting the second workpiece with an opposite-side element (for example, opposite-side element 121). Contacting the second workpiece with an opposite-side element may include, at 412, contacting the second workpiece with an anvil (for example, anvil 122).

At 414, feedstock material is deposited, via at least rotation of the spindle, from the AFSD machine into an aperture (for example, aperture 200 or aperture 300) extending through one or both of the first workpiece and the second workpiece. The feedstock material deposited into the aperture forms a weld nugget (for example, weld nugget 210) that joins the first workpiece to the second workpiece.

At 416, deposition of the feedstock material is confined to substantially within the first workpiece and the second workpiece. Where the aperture extends through the first workpiece and not the second workpiece, feedstock deposition could be confined by placing the machine-side element in contact with the first workpiece during deposition. Where the aperture extends through both the first and second workpieces, feedstock deposition could be confined by placing the machine-side element in contact with the first workpiece during deposition, and by backing the second workpiece with the opposite-side element during deposition.

Method 400 may include alternative or additional steps not illustrated in FIG. 4. For example, where the first workpiece and the second workpiece are clamped via the machine-side element and the opposite-side element, the machine-side and opposite-side elements will be removed from contact with the workpiece assembly following formation of the weld nugget after a predetermined cooling period. The predetermined cooling period can be selected to achieve a desired degree of cooling and/or hardening and to provide a desired degree of bonding between the first workpiece and the second workpiece. Also, post-process steps following formation of the weld nugget may be performed, such as grinding and blending. These and/or other post-process steps may be performed to achieve desired aesthetic characteristics of the weld nugget/workpiece assembly—for example, to remove marks left by feedstock deposition. Alternatively or additionally, deposition marks can be minimized by controlling the axial load applied to feedstock bars (e.g., by a vertical actuator) and the dwell time of the AFSD machine after the axial load is removed. Further, machine-side and opposite-side elements each may respectively include components other than a cylinder and anvil, as described above. Thus, method 400 may include contacting at 408 the first workpiece with a component other than the cylinder, such as a rectangular component having a cylindrical hole, and/or contacting at 412 the second workpiece with a component other than the anvil, such as a static backing surface.

The approaches described herein provide spot welding and the formation of lap joints without the presence of keyholes using consumable materials from an AFSD machine. As such, degraded static and fatigue joint performance associated with keyholes is averted. Further, the disclosed approaches may provide a desirable alternative where other techniques, such as resistance welding, riveting, and fastening, are employed. In some examples, deposited feedstock material that forms joints as described herein may have a density less than or equal to the density of the workpieces the deposited feedstock joins. In such examples, the disclosed approaches may provide joints with savings in weight, for example in contrast to other welding techniques that use a filler material having a higher density than the workpieces that are joined using the filler material. Significant weight savings may be achieved in aerospace applications where hundreds or thousands of joints are typical, and where the use of higher density materials penalizes fuel economy.

The disclosed approaches may be applied to any suitable type of workpiece material, including but not limited to titanium, aluminum, and magnesium alloys, as examples. The solid-state nature of the disclosed techniques may be desirable in applications where materials susceptible to hot cracking are used, such as 7000 series aluminum (e.g., 7050, 7075), and/or where materials not amenable to welding via fusion-based techniques are used, such as magnesium alloys.

The present disclosure includes all novel and non-obvious combinations and subcombinations of the various features and techniques disclosed herein. The various features and techniques disclosed herein are not necessarily required of all examples of the present disclosure. Furthermore, the various features and techniques disclosed herein may define patentable subject matter apart from the disclosed examples and may find utility in other implementations not expressly disclosed herein.

1. A method of joining workpieces, the method comprising:
positioning a workpiece assembly relative to a spindle of an additive friction stir deposition (AFSD) machine, the workpiece assembly comprising a first workpiece and a second workpiece;
clamping the first workpiece to the second workpiece; and
depositing, via at least rotation of the spindle, feedstock material from the AFSD machine into an aperture extending through one or both of the first workpiece and the second workpiece, the feedstock material deposited into the aperture forming a weld nugget that joins the first workpiece to the second workpiece.

2. The method of claim 1, further comprising confining deposition of the feedstock material to substantially within the first workpiece and the second workpiece.

3. The method of claim 2, wherein confining deposition of the feedstock material to substantially within the first workpiece and the second workpiece comprises contacting the first workpiece with a cylinder at least partially surrounding the spindle.

4. The method of claim 2, wherein confining deposition of the feedstock material to substantially within the first workpiece and the second workpiece comprises contacting the first workpiece with a rectangular component having a cylindrical hole.

5. The method of claim 2, wherein confining deposition of the feedstock material to substantially within the first workpiece and the second workpiece comprises contacting the second workpiece with a static backing surface.

6. The method of claim 2, wherein confining deposition of the feedstock material to substantially within the first workpiece and the second workpiece comprises contacting the second workpiece with an anvil.

7. An apparatus, comprising:
a clamp configured to restrain a first workpiece against a second workpiece; and
an additive friction stir deposition (AFSD) machine comprising a spindle, the AFSD machine configured to deposit, via at least rotation of the spindle, feedstock material into an aperture extending through one or both of the first workpiece and the second workpiece, the feedstock material deposited into the aperture forming a weld nugget that joins the first workpiece to the second workpiece.

8. The apparatus of claim 7, wherein the clamp comprises a machine-side element contacting the first workpiece and an opposite-side element contacting the second workpiece.

9. The apparatus of claim 8, wherein the machine-side element comprises a cylinder at least partially surrounding the AFSD machine.

10. The apparatus of claim 9, wherein the cylinder is in contact with the spindle.

11. The apparatus of claim 8, wherein the machine-side element comprises a rectangular component having a cylindrical hole.

12. The apparatus of claim 8, wherein the opposite-side element comprises a static backing surface.

13. The apparatus of claim 8, wherein the opposite-side element comprises an anvil.

14. An apparatus, comprising:
a clamp configured to restrain a first workpiece against a second workpiece to form a workpiece assembly, the clamp comprising a machine-side element contacting the first workpiece and an opposite-side element contacting the second workpiece; and
an additive friction stir deposition (AFSD) machine comprising a spindle, the AFSD machine configured to deposit, via at least rotation of the spindle, feedstock material into a preformed aperture extending through one or both of the first workpiece and the second workpiece of the workpiece assembly, the feedstock material deposited into the aperture forming a lap joint between the first workpiece and the second workpiece.

15. The apparatus of claim 14, wherein the clamp is further configured to confine deposition of the feedstock material to substantially within the first workpiece and the second workpiece.

16. The apparatus of claim 14, wherein the machine-side element comprises a cylinder at least partially surrounding the AFSD machine.

17. The apparatus of claim 16, wherein the cylinder is in contact with the spindle.

18. The apparatus of claim 14, wherein the machine-side element comprises a rectangular component having a cylindrical hole.

19. The apparatus of claim 14, wherein the opposite-side element comprises a static backing surface.

20. The apparatus of claim 14, wherein the opposite-side element comprises an anvil.
